(19) United States
(12) Patent Application Publication
(10) Pub. No.: US 2006/0108827 A1
(43) Pub. Date: May 25, 2006

(54) Automobile Armrest

(76) Inventors: Douglas Tharalson, Agoura, CA (US); Diana Tharalson, Agoura, CA (US)

Correspondence Address: CISLO & THOMAS, LLP, 233 WILSHIRE BLVD, SUITE 900, SANTA MONICA, CA, 90401-1211, US

(21) Appl. No.: 11/215,370

(22) Filed: Aug. 29, 2005

Related U.S. Application Data
(60) Provisional application No. 60/605,037, filed on Aug. 27, 2004.

(51) Int. Cl. B60J 9/00

(52) U.S. Cl. 296/153

(57) ABSTRACT

An armrest for an automobile comprises an elongated body having rounded corners at each end, a longitudinal slot within the elongated body, and an elongated sleeve adapted to be accommodated into the slot. The sleeve is configured to keep an automobile window glass from cutting into the body and to support the body of the armrest onto a partially raised window glass of an automobile door.

### CROSS-REFERENCE TO RELATED APPLICATIONS

This application claims the benefit of U.S. Provisional Patent Application No. 60/605,037, filed on Aug. 27, 2004, which is incorporated herein in its entirety by reference.

### BACKGROUND

Armrests in vehicles such as automobiles are generally known. Such armrests are usually adjustable to a certain extent but not generally comfortable. There is no provision for storage of personal items such as wallets, keys, coins, cellular telephones, cups and the like. Furthermore, these known armrests typically do not include a removable fabric cover which can be taken off for cleaning or maintenance as needed. Moreover, most of the known armrests cannot be securely installed on a partially raised window glass of an automobile.

### SUMMARY

Exemplary embodiments disclosed herein are generally directed to an automobile armrest.

In accordance with one aspect of the invention, the automobile armrest comprises a substantially elongated body having rounded corners at each end, a longitudinal slot within the substantially elongated body and a substantially elongated sleeve adapted to be accommodated into the longitudinal slot. The substantially elongated sleeve is configured to keep automobile window glass from cutting into the substantially elongated body and to support the substantially elongated body onto a partially raised window glass of an automobile door.

This and other aspects of the invention will become apparent from a review of the accompanying drawings and the following detailed description of the invention.

### BRIEF DESCRIPTION OF THE DRAWINGS

The present invention is generally shown by way of reference to the accompanying drawings in which:

FIG. 1 is a side perspective view of an automobile armrest in accordance with an exemplary embodiment of the present invention;

FIG. 2 is an end view of the automobile armrest of FIG. 1;

FIG. 3 is a side perspective view of a removable fabric cover for the automobile armrest of FIG. 1;

FIG. 4 is a side elevation showing an automobile armrest being used in accordance with the present invention;

FIG. 5 is a side perspective view of an automobile armrest in accordance with another exemplary embodiment of the present invention;

FIG. 6 is an end view of the automobile armrest of FIG. 5; and

FIG. 7 is a side perspective view of a spring-loaded window support sleeve for use with the automobile armrest of the present invention.

### DETAILED DESCRIPTION

The detailed description set forth below in connection with the appended drawings is intended as a description of exemplary embodiments and is not intended to represent the only forms in which the exemplary embodiments may be constructed and/or utilized. The description sets forth the functions and the sequence of steps for constructing and operating the exemplary embodiments in connection with the illustrated embodiments. However, it is to be understood that the same or equivalent functions and sequences may be accomplished by different embodiments that are also intended to be encompassed within the spirit and scope of the present invention.

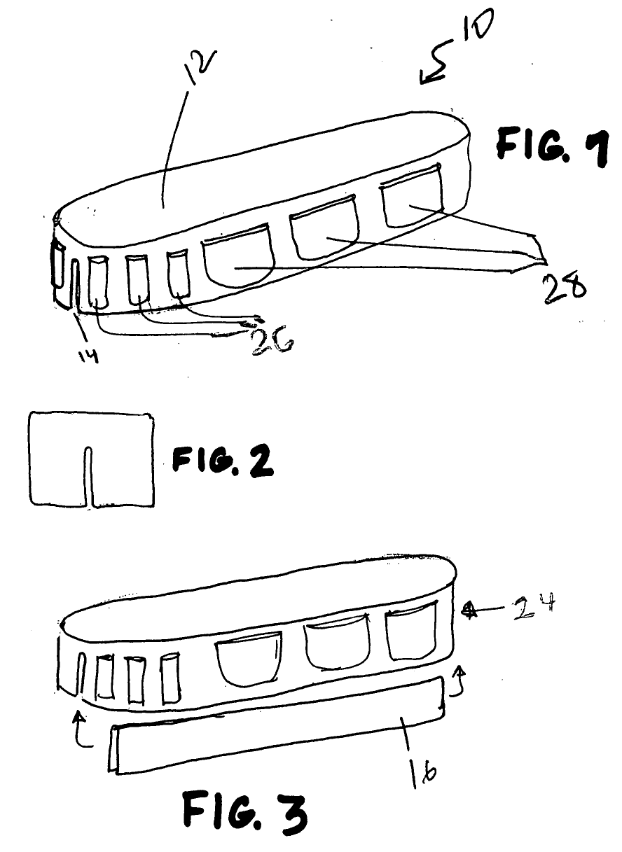

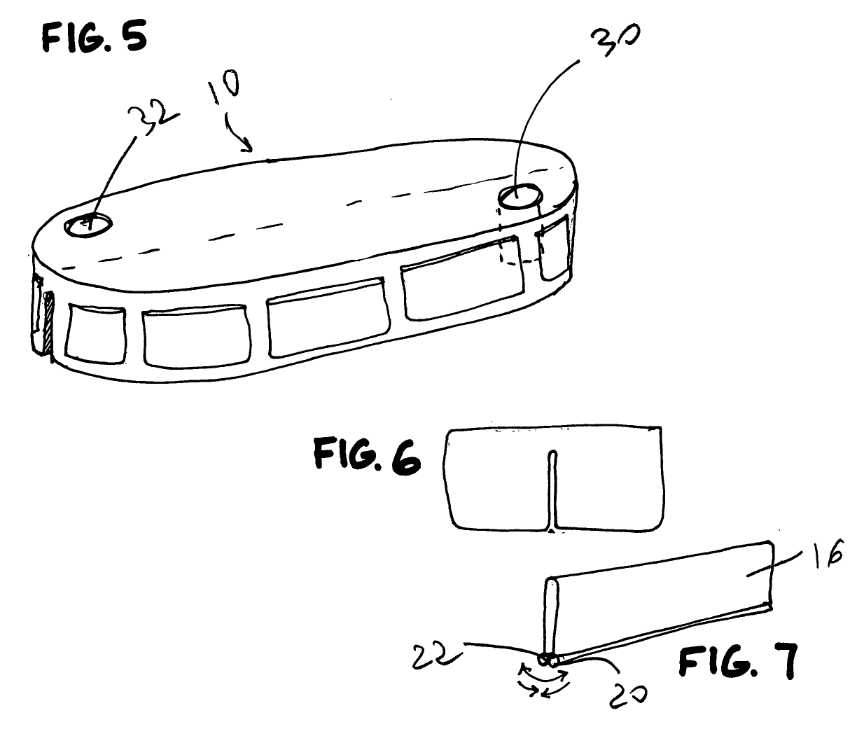

Some embodiments of the present invention will be described in detail with reference to an automobile armrest, as generally shown in FIGS. 1-7. Additional embodiments, features and/or advantages of the invention will become apparent from the ensuing description or may be learned by practicing the invention. In the figures, the drawings are not to scale with like numerals referring to like features throughout both the drawings and the description.

FIG. 1 is a side perspective view of an automobile armrest 10 in accordance with an exemplary embodiment of the present invention. Automobile armrest 10 has a generally elongated body 12 with rounded corners at each end. Elongated body 12 may be made of foam or other suitable material. Elongated body 12 is provided with a longitudinal slot 14 (FIG. 1) which is adapted to receive an elongated plastic sleeve 16 (FIG. 3) of a generally U-shaped cross section.

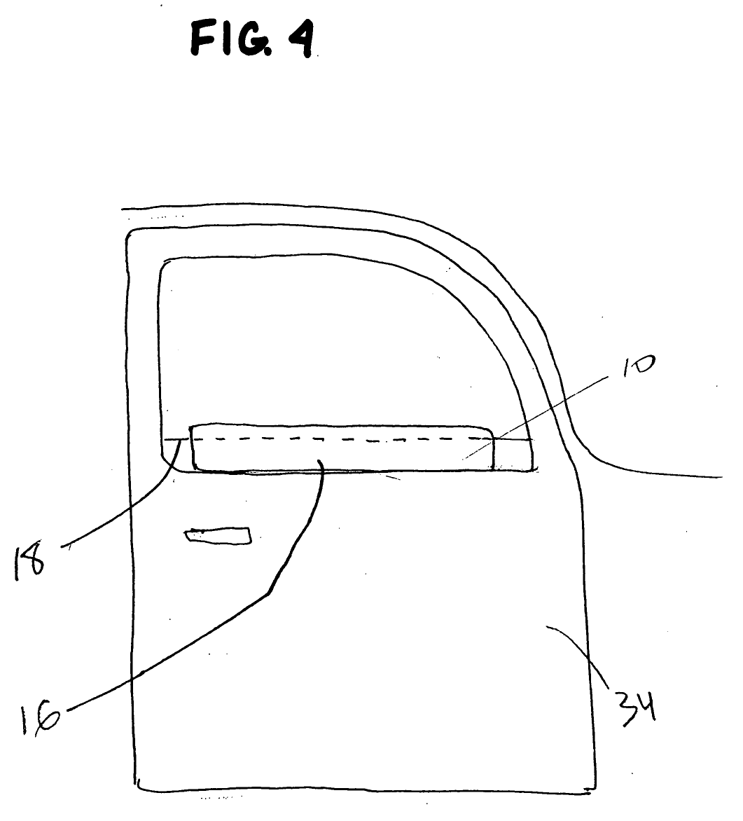

Plastic sleeve 16 is adapted to snugly grip the two opposing sides of a partially raised automobile window glass 18, as generally depicted in FIG. 4. Sleeve 16 may be made of spring-loaded plastic material with “memory”, i.e. the two sides of sleeve 16 are naturally biased toward each other. Sleeve 16 may be provided with elastic tubular ends 20, 22 (FIG. 7) adapted to grip the glass surface of the automobile window. Tubular ends 20, 22 may be made of rubber or other suitable material. Plastic sleeve 16 is configured to keep the automobile window glass from cutting into the foam body (12) of armrest 10 and eventually weakening it to the point that it falls and comes apart. Plastic sleeve 16 is also configured to hold foam body 12 of armrest 10 to partially raised window glass 18 of automobile door 34 (FIG. 4).

Armrest 10 may include a removable fabric cover 24 (FIG. 3). Fabric cover 24 may be removed for cleaning or maintenance and may be provided with two holding straps on the bottom to hold the two sides together. Fabric cover 24 may be made of suitable pre-shrunk material such as canvas, denim or the like. A nylon cover would not be suitable as it would be too slippery. Plastic sleeve 16 may be sewn into fabric cover 24. Alternatively, plastic sleeve 16 may be glued into elongated foam body 12. Other suitable materials may be utilized to construct the armrest of the present invention, as needed.

Automobile armrest 10 may be provided with front side pockets 26 that can accommodate pens, pencils, cigarette lighter(s) and the like. Additionally, armrest 10 may be provided with somewhat larger rear side pockets 28 that are designed to accommodate wallet(s), notepad(s), coins and the like. Moreover, armrest 10 may be provided with two or more cup holders, such as cup holders 30, 32 in FIG. 5. Also, a cellular telephone pocket (not shown) may be provided on each side of longitudinal slot 14 (FIG. 1), as needed.

Automobile armrest 10 may be made in a variety of dimensions, as needed. For example, armrest 10 may be manufactured from 3 inch foam with a 8 inch width and a 20 inch length. The cup holder may have a 2.5 inch diameter and a 2 inch depth. Other implementations are possible, as desired. The armrest of the present invention may be sold in packages of two armrests in one package.

The automobile armrest of the present invention may be assembled in other ways and/or with other suitable components and/or materials, as long as there is no departure from the intended purpose and scope of the present invention. The exemplary embodiments described hereinabove are merely illustrative of the general principles of the present invention. Various design modifications may be employed that would reside within the scope of the invention. Thus, by way of example, but not of limitation, alternative configurations may be utilized in accordance with the teachings herein. Accordingly, the drawings and description are illustrative and not meant to be a limitation thereof.

Moreover, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced. Thus, it is intended that the invention cover all embodiments and variations thereof as long as such embodiments and variations come within the scope of the appended claims and their equivalents.

What is claimed is:

1. An automobile armrest, comprising:
a substantially elongated body having rounded corners at each end;
a longitudinal slot within said substantially elongated body; and
a substantially elongated sleeve adapted to be accommodated into said longitudinal slot, said substantially elongated sleeve being configured to keep automobile window glass from cutting into said substantially elongated body and to support said substantially elongated body onto a partially raised window glass of an automobile door.

2. The automobile armrest of claim 1, wherein said substantially elongated sleeve is made of plastic material.

3. The automobile armrest of claim 1, wherein said substantially elongated sleeve is made of spring-loaded plastic material.

4. The automobile armrest of claim 1, wherein said substantially elongated sleeve is adapted to securely grip the glass surface of an automobile window.

5. The automobile armrest of claim 1, further comprising a removable fabric cover for said substantially elongated body.

6. The automobile armrest of claim 1, further comprising a plurality of side pockets.

7. The automobile armrest of claim 6, wherein said side pockets are adapted to accommodate pens, pencils, cigarette lighters.

8. The automobile armrest of claim 6, wherein said side pockets are adapted to accommodate wallets, notepads, coins.

9. The automobile armrest of claim 1, further comprising at least one cup holder.

10. The automobile armrest of claim 1, further comprising at least one cellular telephone pocket.

11. The automobile armrest of claim 1, further comprising a cellular telephone pocket being disposed on each side of said longitudinal slot.
